(19) United States
(12) Patent Application Publication
(10) Pub. No.: US 2006/0226236 A1
(43) Pub. Date: Oct. 12, 2006

(54) Optical magnifier system and method

(76) Inventors: Mary A. Cullen, Atlanta, GA (US); Craig Rusert, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/398,994

(22) Filed: Apr. 6, 2006

Related U.S. Application Data
(60) Provisional application No. 60/669,203, filed on Apr. 7, 2005.

(51) Int. Cl. G06K 19/00

(52) U.S. Cl. 235/487

(57) ABSTRACT

A system and method for an optical magnifier, wherein an optical magnifier is actually or virtually coupled to an item of printed media, such as, for example, a restaurant menu, road map, book, magazine, brochure or the like. Accordingly, the magnifier and printed media are kept in close proximity to each other, wherein the magnifier may be easily and conveniently accessed to view fine print and other small symbols.

Priority based on U.S. Provisional Patent Application, Ser. No. 60/669,203, filed Apr. 7, 2005, and entitled, “Optical Magnifier System and Method”, is claimed.

### TECHNICAL FIELD

The present invention relates generally to reading aides, and more specifically to an. optical magnifier system and method comprising an optical magnifier that is coupled to a reading article, such as, for example, a restaurant menu, road map, transportation schedule, book, magazine, brochure or the like, wherein the optical magnifier may be easily and efficiently accessed for reading fine print and other small symbols.

### BACKGROUND OF THE INVENTION

Certain reading articles are designed to be small and portable, such as, for example, pocket dictionaries, guidebooks, and note cards. Other reading articles, such as, for example, road maps and telephone directories, can become extremely large given the sizeable amount of information that must be conveyed. In both instances, such printed media have a limited amount of space in which to provide information; and as such, small print is often utilized to convey the pertinent information.

For individuals with normal vision, reading text having small print can be difficult and can often result in significant eyestrain. As eyesight typically decreases with age, however, reading text becomes increasingly more difficult, no matter the size of the print that is presented. Accordingly, reading aides having optical magnifiers have been developed to assist individuals when reading small text and other fine print.

Unfortunately, such reading aides are frequently not readily available when needed. Additionally, certain reading aides are not portable. Typically, such reading aides are large and bulky devices having optical magnifiers, which are stored in designated reading areas.

Conversely, reading aides that are small and portable are easily lost when not kept with the book or printed media. Moreover, reading aides that are permanently affixed to the reading article may not be transferred and utilized with other printed publications.

Therefore, it is readily apparent that there is a need for a system for an optical magnifier, wherein the optical magnifier may be utilized on numerous reading articles to view small text and other fine print. Moreover, there is a need for such a system that offers a small, portable optical magnifier that may be kept in the immediate vicinity of the reading article.

### BRIEF SUMMARY OF THE INVENTION

Briefly described, in a preferred embodiment, the present invention overcomes the above-mentioned disadvantages and meets the recognized need for such a device by providing a system and method for an optical magnifier, wherein an optical magnifier, typically the size of a credit card or wallet, and a reading article are actually or virtually “connected” as a system that is designed to keep the magnifier and reading article in close proximity to each other for the convenience of the end-user. Accordingly, when a reading aide is most desirable, the magnifier may be easily and conveniently accessed to view fine print and other small symbols.

According to its major aspects and broadly stated, the present invention in its preferred form comprises an optical magnifier, a coupler and a reading article, wherein the reading article is an item of printed media, such as, for exemplary purposes only, a restaurant menu, road map, book, magazine, brochure, or the like.

The optical magnifier can have credit card-sized form factor having a thin magnifying lens integrally formed therein for optically enlarging an adjacently disposed viewing area. The optical magnifier can be permanently or removably connected to the reading article via the coupler, so as to conveniently provide an optical reading aide in close proximity to the reading article.

In general, in one aspect, the invention features a magnifier system, including a reading article, an optical magnifier coupled to the reading article and means for coupling the reading article to the optical magnifier.

In one implementation, the means for coupling the reading article to the optical magnifier includes a pocket disposed on the reading article and a tether disposed between the pocket and the optical magnifier.

In another implementation, the tether has a first end and a second end.

In another implementation, the system further includes a first aperture disposed on the optical magnifier and connected to the first end, and a second aperture disposed on the pocket and connected to the second end.

In still another implementation, the pocket includes a front wall and a back wall disposed between the front wall and the reading article.

In still another implementation, the front wall and the back wall have an area differential.

In yet another implementation, the means for coupling the reading article to the optical magnifier includes a fastener disposed on the reading article and a tether disposed between the fastener and the optical magnifier.

In another implementation the fastener can be a needle, clasp, clip, clamp, adhesive assembly, magnet assembly and a hook-and-loop fastener assembly.

In another implementation, the optical magnifier and the reading article are virtually coupled.

In another implementation, a pocket is disposed between the reading article and the optical magnifier.

In another implementation, the optical magnifier includes a border and a magnifying lens disposed on the border.

In another aspect, the invention features a magnifier kit, including a pocket adapted to be affixed to a reading article, an optical magnifier for insertion and removal from the pocket and a tether for connection between the reading article and the optical magnifier.

In one implementation, the optical magnifier is a planar body.

In another implementation, the planar body comprises a magnifying lens disposed within a border.

In another aspect, the invention features a method of magnifying print on a reading article, including obtaining the reading article, affixing a coupler on the reading article and using an optical magnifier to read the print on the reading article, wherein the optical magnifier is disposed on the coupler.

In one implementation, the method further includes inserting the optical magnifier into the coupler.

In another implementation, the method further includes removing the optical magnifier from the coupler.

In another implementation, the coupler is a pocket affixed to the reading article and a tether connected between the pocket and the optical magnifier.

In another implementation, the coupler is a pocket affixed to the reading article.

In another implementation, using the optical magnifier to read the text includes establishing a distance between the reading article and the optical magnifier to focus the print on the reading article.

In another aspect, the invention features a system for use and association with a reading article, including in combination an optical magnifier for coupling to the reading article and a coupler for disposition between the reading article and the optical magnifier.

In one implementation, the system further includes a pocket for affixation on the reading article.

In another implementation, the pocket is permanently affixed to the reading article.

In another implementation, the pocket is removably affixed to the reading article.

In another implementation, the combination is movable from the reading article to a second reading article.

In another implementation, the coupler includes a tether having a first end and a second end, and a fastener for affixation to the reading article and disposed on one of said first and second ends.

In another implementation, the fastener is selected from the group including needle, clasp, clip, clamp, adhesive, magnetic assembly and a hook-and-loop fastener assembly.

If the coupler is utilized to removably connect the optical magnifier to the reading article, the system of the present invention may be advantageously utilized as a means for advertising and marketing. More specifically, textual and/or pictorial advertising may be printed on the surface of the optical magnifier such that an individual utilizing the optical magnifier system can remove the optical magnifier from the reading article and take away the optical magnifier having the advertising printed thereon. The system and method of the present invention can be especially advantageous in the food service industry, wherein optical magnifiers having advertising printed thereon may be removably attached to restaurant menus as reading aides. Upon removal of the optical magnifiers, the menus can be easily refilled with new optical magnifiers by the restaurant host or hostess.

Thus, a feature and advantage of the present invention is its ability to function as a vehicle for advertising.

Another feature and advantage of the present invention is its ability to deliver advertising to a retailer's preferred consumer, wherein the preferred consumer is given a useful, functional article to keep and take home, which displays the retailer's name, logo and/or contact information thereon.

Still another feature and advantage of the present invention is that it incorporates a reading aide as an integral part of a reading article, wherein the reading aide may be easily and conveniently accessed when it is needed the most.

Yet another feature and advantage of the present invention is that it provides a reading aide that may be permanently affixed to the reading article, thereby preventing loss or misplacement of the reading aide.

Still yet another feature and advantage of the present invention is that it provides a reading aide that may be removably attached to the reading article, wherein the reading aide may be removed and utilized on another reading article.

A further feature and advantage of the present invention is that it eliminates the need to carry reading glasses at all times for the relatively few occasions when they might be needed.

Still a further feature and advantage of the present invention is that it allows publishers to print more information on the reading articles, such as, for example, by utilizing smaller fonts, symbols, tables, graphs, figures, and/or the like, wherein such smaller print may be read utilizing the optical magnifier.

Yet a further feature and advantage of the present invention is that the optical magnifier allows publishers to utilize smaller print, thus allowing the creation of smaller, lighter, and more portable reading articles.

Still yet a further feature and advantage of the present invention is its small size and durability, which yields a portable reading aide that may be carried without the risk of damage.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a view of an optical magnifier system according to a preferred embodiment of the present invention;

FIG. 2 is a view of an optical magnifier system according to an alternate embodiment of the present invention;

FIG. 2A is a view of an optical magnifier system according to an alternate embodiment of the present invention;

FIG. 3 is a view of an optical magnifier system according to an alternate embodiment of the present invention;

FIG. 4 is a view of an optical magnifier system according to an alternate embodiment of the present invention;

FIG. 5 is a view of an optical magnifier system according to an alternate embodiment of the present invention;

FIG. 6 is a view of an optical magnifier system according to an alternate embodiment of the present invention; and

FIG. 7 is a view of optical magnifiers of an optical magnifier system according to an alternate embodiment of the present invention.

### DETAILED DESCRIPTION OF THE PREFERRED AND SELECTED ALTERNATIVE EMBODIMENTS

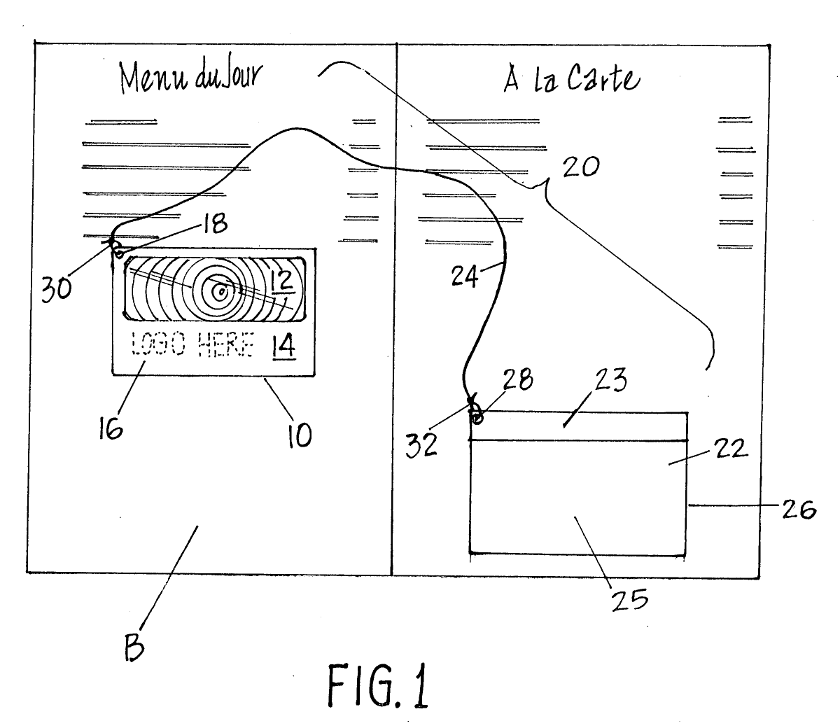

In describing the preferred and selected alternative embodiments of the present invention, as illustrated in FIGS. 1-7, specific terminology is employed for the sake of clarity. The invention, however, is not intended to be limited to the specific terminology so selected, and it is to be understood that each specific element includes all technical equivalents that operate in a similar manner to accomplish similar functions.

Referring first to FIG. 1, the present invention in a preferred embodiment generally includes optical magnifier 10, wherein optical magnifier 10 is generally disposed on book B via coupler 20. The system and method of the present invention is preferably utilized in conjunction with book B; however, it should be recognized that the present invention is suitable for utilization with other reading articles. Therefore, while the present invention is described conveniently in association with a book, it is not limited to application or implementation with only such printed media. As such, it is contemplated in an alternative embodiment that the present invention could be utilized with other reading articles, such as, for exemplary purposes only, restaurant menus, road maps, magazines, transportation schedules, brochures, booklets, telephone directories and the like.

In a typical embodiment, optical magnifier 10 is preferably a thin, lightweight planar card-like body having magnifying lens 12 and border 14. Preferably, magnifying lens 12 is substantially centrally disposed within optical magnifier 10, wherein magnifying lens 12 functions to optically enlarge objects which are viewed therethrough. For example, magnifying lens 12 can be positioned over printed text, wherein the text is optically enlarged when viewed through magnifying lens 12. Adjustments, generally the distance between magnifying lens 12 and book B, can subsequently be performed to meet personal and subjective viewing needs. It is appreciated that the focal length can vary depending on the viewer's personal vision and the properties of magnifying lens 12. Therefore, it is further appreciated that magnifying lens 12 can have different optical properties such as focal length.

Preferably, border 14 surrounds magnifying lens 12, wherein border 14 is a flat surface having an area that is suitable for displaying print 16 thereon. Print 16 preferably includes alphanumeric text, symbols, figures, drawings, pictures and/or the like, which are preferably imprinted onto border 14 via mechanical printing devices, ink stamps, adhesive labels and/or the like. Print 16 could preferably include useful information pertaining to the reading article, such as, for example, glossaries, tables, charts, map scales, legends, keys and/or other indices. Additionally, print 16 could be preferably utilized for marketing and advertising, wherein print 16 could display the name, logo, address, telephone number, and/or Internet URL address of the advertiser.

In a typical implementation, border 14 can include a region 15 onto which print 16 is affixed. Region 15 can further be larger with respect to the remaining portions of border 14 to allow a gripping region for a user to grasp optical magnifier 10 advantageously. Furthermore, border 14 is generally a planar body having a large opening therethrough onto which magnifying lens 12 is affixed. Border 14 further preferably includes aperture 18 for receiving a portion of coupler 20 therewithin, as more fully described below.

In a typical embodiment, coupler 20 is disposed between optical magnifier 10 and book B. Coupler 20 preferably functions to attach optical magnifier 10 to book B, wherein coupler 20 preferably comprises pocket 22 and tether 24. Preferably, pocket 22 is adapted to receive and retain optical magnifier 10 therewithin, wherein pocket 22 comprises adhesive backing 26 and aperture 28. Adhesive backing 26 preferably functions to secure pocket 22 to book B, wherein pocket 22 and adhesive backing 26 are preferably optically transparent. Thus, placement of pocket 22 on a reading article preferably does not block or otherwise obstruct the viewing area of the reading article.

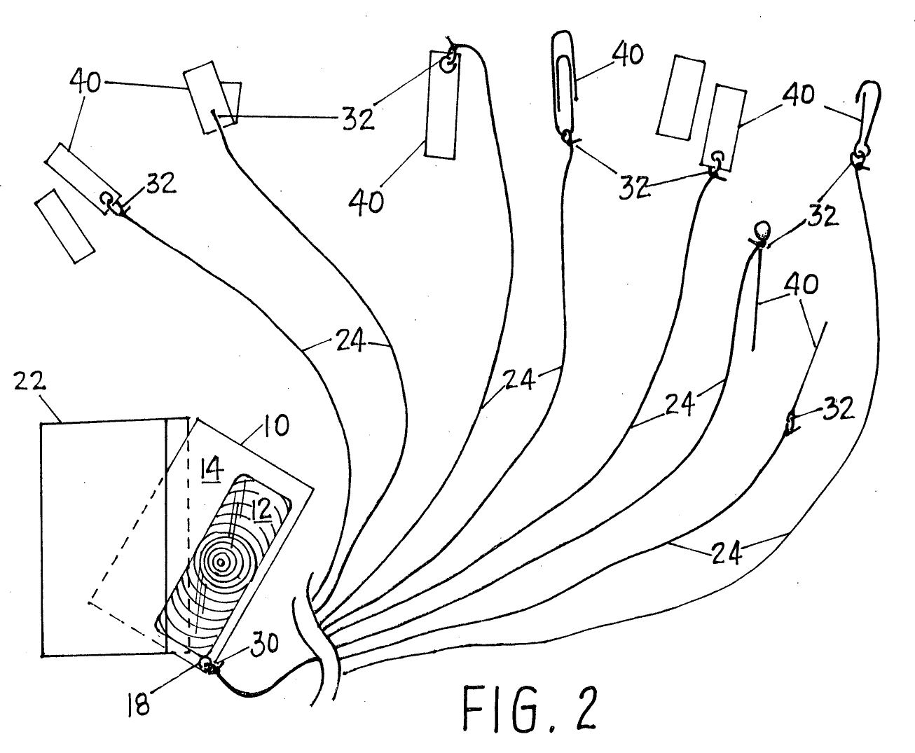

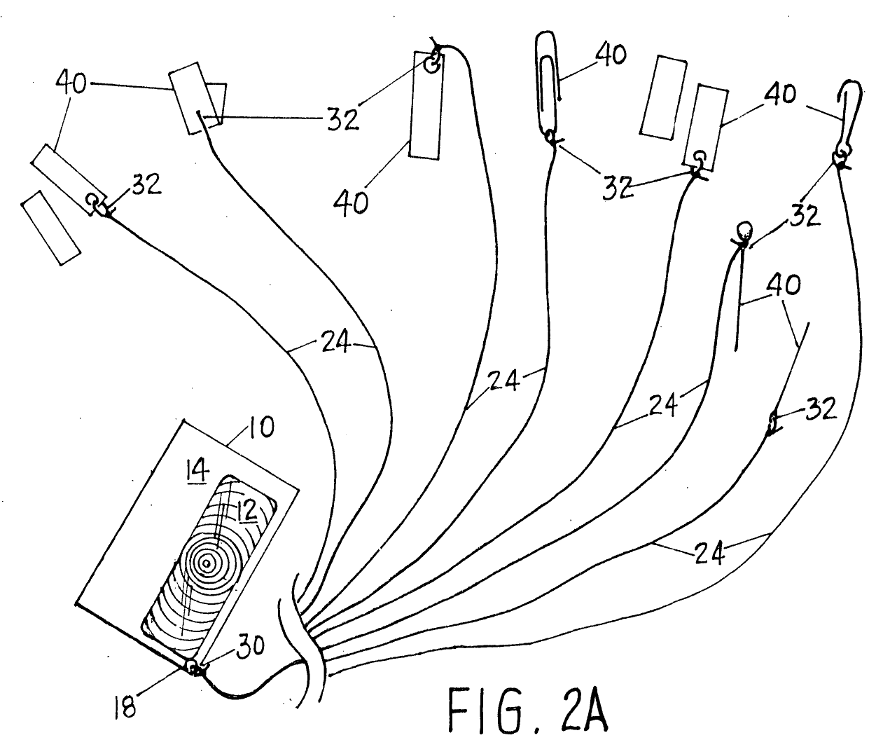

In one embodiment, pocket 22 can include back wall 23 and front wall 25 wherein three of the four sides of back wall 23 and front wall 25 are connected thereby leaving fourth open side 27 into which optical magnifier 10 can be inserted and removed. In a typical implementation, back wall 23 has a larger area than front wall 25. The area differential can help a user remove optical magnifier 10 from pocket 22 because larger area back wall 23 can provide a surface onto which a user can leverage his or her fingers to move front wall 25 away from back wall 23 to enlarge open side 27 for insertion and removal of optical magnifier 10. In accordance with FIG. 2A, it is recognized by one of ordinary skill in the art that pocket 22 is an optional component, provided or not according to the needs of the user and the application.

Preferably, tether 24 comprises first end 30 and second end 32, wherein first end 30 is affixed to aperture 18 of optical magnifier 10, and wherein second end 32 is affixed to aperture 28 of pocket 22. In a typical embodiment, tether 24 can be any suitable length of string, ribbon, band and the like. In a typical implementation, tether 24 can be flexible or stretchable or non-stretchable.

It is recognized, in an alternative embodiment, that coupler 20 could lack tether 24 and apertures 18 and 28, wherein optical magnifier 10 is removably secured to book B via pocket 22. In such form, coupler 20 and optical magnifier 10 are considered to be “virtually” tethered, wherein a user is obligated to return and stow optical magnifier 10 within pocket 22 of coupler 20 after use.

Accordingly, the present invention preferably incorporates optical magnifier 10 as an integral part of a reading article, thus preventing loss or misplacement of optical magnifier 10, wherein optical magnifier 10 may be easily and conveniently accessed when it is needed the most. Preferably, optical magnifier 10 may be utilized for reading fine print and other small symbols, thus allowing publishers to print more information on the reading articles, such as, for example, by utilizing smaller fonts, symbols, tables, graphs, figures, and/or the like. Moreover, the utilization of smaller, yet readable, print preferably enables the creation of smaller, more portable reading articles. Additionally, optical magnifier 10 may be utilized as a bookmarker.

It is contemplated, in an alternative embodiment, that optical magnifier 10 could be removably secured to the reading article. In such an embodiment, the present invention may be utilized as a means for advertising, wherein print 16 of optical magnifier 10 includes textual and/or pictorial advertising. Thus, advertising media may be delivered to a retailer's preferred consumer, wherein the preferred consumer is given a useful, functional article to keep and take home, which displays the retailer's name, logo and/or contact information thereon.

For example, the system and method of the present invention could be utilized in the food service industry, wherein optical magnifier 10 may be removably attached to a restaurant menu as a reading aide. Accordingly, the restaurant consumer may remove optical magnifier 10 from the menu and take away a useful article having advertising displayed thereon. Subsequently, the menus can be easily refilled with new optical magnifiers by the restaurant host or hostess.

A similar approach can be used in other industries, as for non-limiting example, the transportation industry for train, airplane, and bus schedules. Because of the voluminous data relating to transportation departure and arrival times, transportation schedules are typically printed utilizing small text. Accordingly, optical magnifier 10 may be advantageously attached to the transportation schedule and utilized as a reading aide. Moreover, optical magnifier 10 could include advertising printed thereon, wherein optical magnifier 10 may be permanently or removably secured to the transportation schedule.

In another alternative embodiment, second end 32 of tether 24 could be directly affixed to the reading article, such as book B.

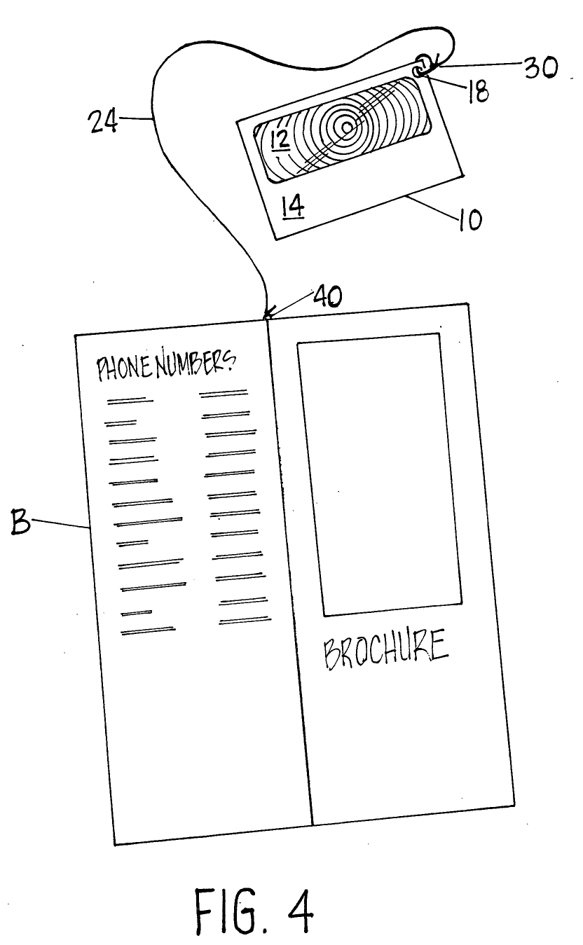

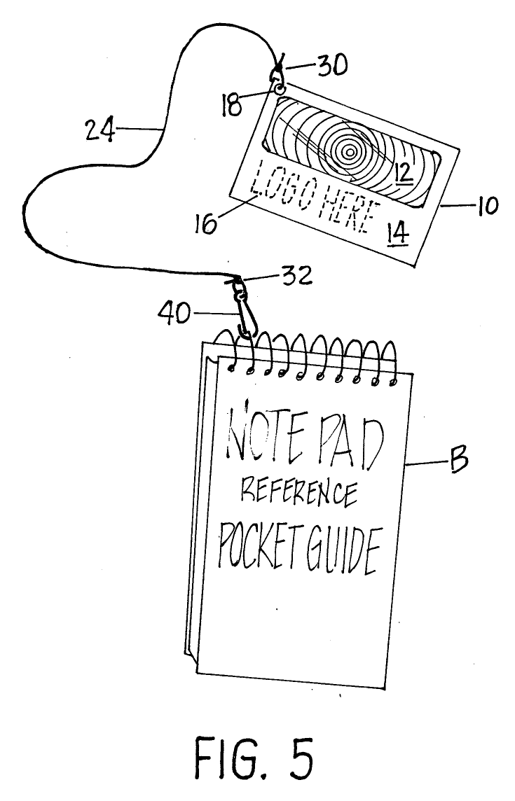

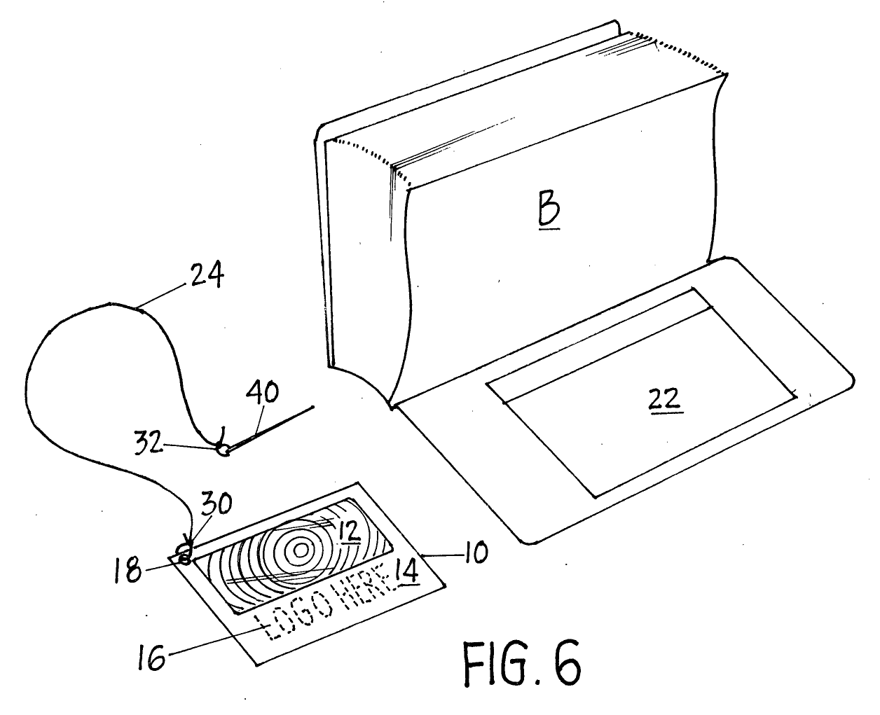

FIG. 2 is a view of an optical magnifier system according to an alternate embodiment of the present invention. In an alternative embodiment, second end 32 of tether 24 could include fastener 40. In a typical embodiment, fastener 40 can have a variety of form factors, including, but not limited to a needle, clasp, clip, clamp, adhesive assembly, magnet assembly and/or a hook-and-loop fastener assembly. It is appreciated that the different fasteners have several different advantages. For example, a needle can be advantageous for temporary affixation to software reading articles. A clasp can be useful for connection to a binder or a spiral bound reading article. A clip, such. as a paperclip can be advantageous for temporary affixation to a page of a reading article. A clamp can likewise be advantageous for temporary affixation to a page or cover of a reading article. Adhesive, with either a strong tack or weak tack can be implemented for either temporary or permanent affixation to the reading article. Magnet assemblies, hook and loop fasteners, and the like can be used for temporary affixation to the reading article. As way of example, FIG. 4 is a view of an optical magnifier system according to an alternate embodiment of the present invention; FIG. 5 is a view of an optical magnifier system according to an alternate embodiment of the present invention; and FIG. 6 is a view of an optical magnifier system according to an alternate embodiment of the present invention. It is recognized that a combination of optical magnifier 10, tether 24 and fastener 40 can be provided to a user for the user's subsequent use and association with a reading article. Advantageously, the combination can be transferred from the reading article to another reading article at the user's discretion and convenience.

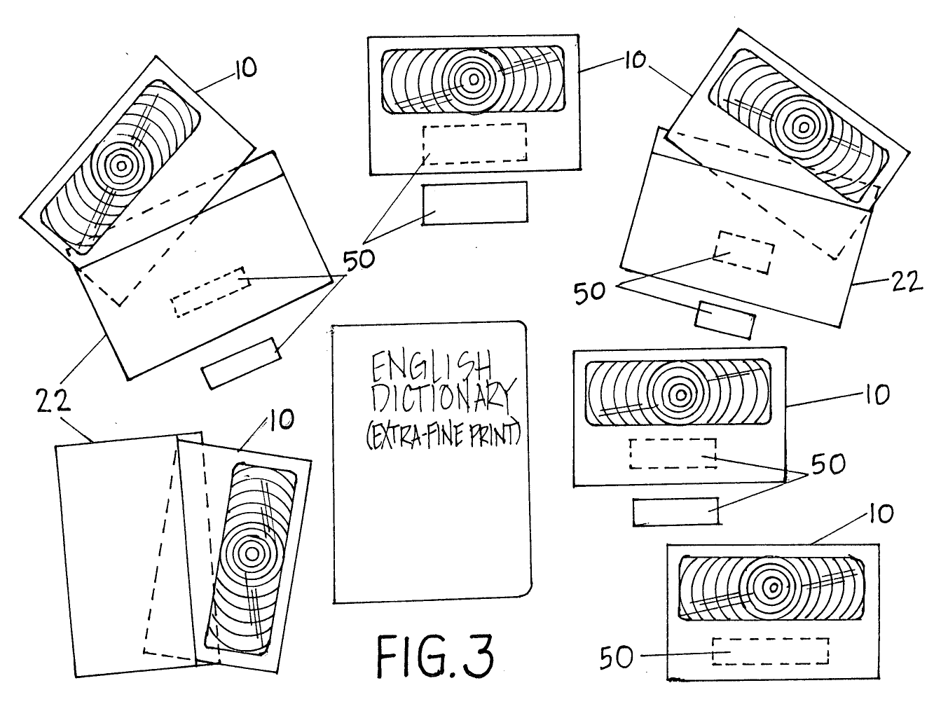

FIG. 3 is a view of an optical magnifier system according to an alternate embodiment of the present invention. In the alternative embodiment as illustrated, pocket 22 could include fastener 50 disposed on the rear side thereof. In a typical embodiment, fastener 50 could embody an adhesive assembly, magnet assembly and/or a hook-and-loop fastener assembly and the like. As described above, the adhesive assembly can have a high tack or low tack depending on the desired affixation strength.

In still yet another alternative embodiment, coupler 20 could lack pocket 22.

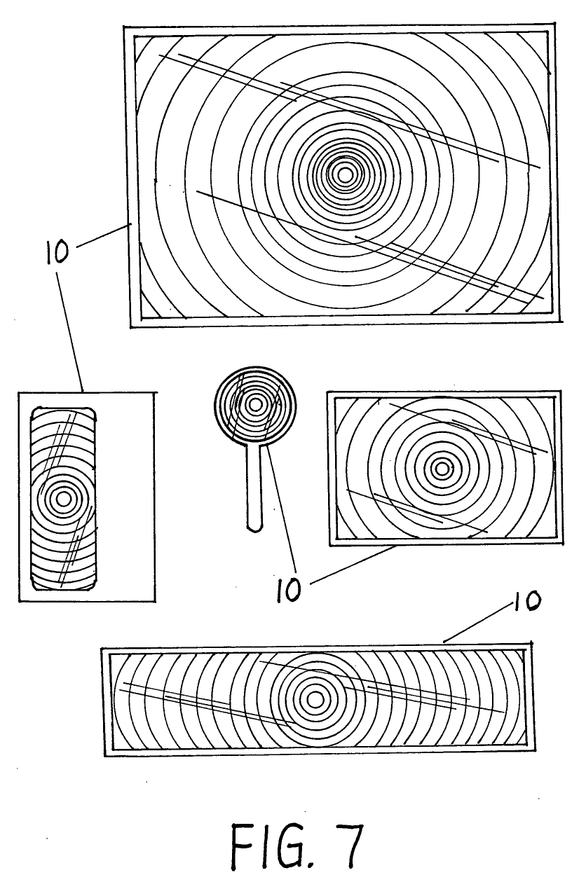

In a further alternative embodiment, as best shown with reference to FIG. 7, optical magnifier 10 could embody other suitable shapes and/or sizes.

In still a further alternative embodiment, print 16 could be disposed on magnifying lens 12 of optical magnifier 10.

In yet a further alternative embodiment, optical magnifier 10 could lack border 14, wherein optical magnifier 10 merely comprises magnifying lens 12.

In still yet a further alternative embodiment, optical magnifier 10 could lack border 14, wherein optical magnifier 10 comprises border strip 15, wherein border strip 15 is a flat elongated surface for grasping optical magnifier 10.

In still another alternative embodiment, optical magnifier 10 could lack aperture 18, wherein first end 30 of tether 24 may be affixed to optical magnifier 10 via adhesives, staples, clips, or other suitable fastening means.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is- not limited to the specific embodiments illustrated herein, but is limited only by the following claims.

What is claimed is:

1. A magnifier system, comprising:
a reading article;
an optical magnifier coupled to the reading article; and
means for coupling the reading article to the optical magnifier.

2. The system as claimed in claim 1 wherein the means for coupling the reading article to the optical magnifier comprises:
a pocket disposed on the reading article; and
a tether disposed between the pocket and the optical magnifier.

3. The system as claimed in claim 2 wherein the tether has a first end and a second end.

4. The system as claimed in claim 3 further comprising a first aperture disposed on the optical magnifier and connected to the first end, and a second aperture disposed on the pocket and connected to the second end.

5. The system as claimed in claim 2 wherein the pocket comprises:
a front wall; and
a back wall disposed between the front wall and the reading article.

6. The system as claimed in claim 5 wherein the front wall and the back wall have an area differential.

7. The system as claimed in claim 1 wherein the means for coupling the reading article to the optical magnifier comprises:
a fastener disposed on the reading article; and
a tether disposed between the fastener and the optical magnifier.

8. The system as claimed in claim 7 wherein said fastener is selected from the group consisting of: needle, clasp, clip, clamp, adhesive, magnetic assembly and a hook-and-loop fastener assembly.

9. The system as claimed in claim 1 wherein the optical magnifier and the reading article are virtually coupled.

10. The system as claimed in claim 9 wherein a pocket is disposed between the reading article and the optical magnifier.

11. The system as claimed in claim 1 wherein the optical magnifier comprises:
a border; and
a magnifying lens disposed on the border.

12. A magnifier kit, comprising:
a pocket adapted to be affixed to a reading article;
an optical magnifier for insertion and removal from the pocket; and
a tether for connection between the reading article and the optical magnifier.

13. The kit as claimed in claim 12 wherein the optical magnifier is a planar body.

14. The kit as claimed in claim 13 wherein the planar body comprises a magnifying lens disposed within a border.

15. A method of magnifying print on a reading article, comprising:
obtaining the reading article;
affixing a coupler on the reading article; and
using an optical magnifier to read the print on the reading article,
wherein the optical magnifier is disposed on the coupler.

16. The method as claimed in claim 15 further comprising inserting the optical magnifier into the coupler.

17. The method as claimed in claim 15 further comprising removing the optical magnifier from the coupler.

18. The method as claimed in claim 15 wherein the coupler is a pocket affixed to the reading article and a tether connected between the pocket and the optical magnifier.

19. The method as claimed in claim 15 wherein the coupler is a pocket affixed to the reading article.

20. The method as claimed in claim 15 wherein using the optical magnifier to read the text comprises establishing a distance between the reading article and the optical magnifier to focus the print on the reading article.

21. A system for use and association with a reading article, comprising in combination:
an optical magnifier for coupling to the reading article; and
a coupler for disposition between the reading article and said optical magnifier.

22. The system as claimed in claim 21 further comprising a pocket for affixation on the reading article.

23. The system as claimed in claim 22, wherein said pocket is permanently affixed to the reading article.

24. The system as claimed in claim 22, wherein said pocket is removably affixed to the reading article.

25. The system as claimed in claim 21, wherein said combination is movable from the reading article to a second reading article.

26. The system as claimed in claim 21, wherein said coupler comprises:
a tether having a first end and a second end; and
a fastener for affixation to the reading article and disposed on one of said first and second ends.

27. The system as claimed in claim 26 wherein said fastener is selected from the group consisting of: needle, clasp, clip, clamp, adhesive, magnetic assembly and a hook-and-loop fastener assembly.
